(19) United States
(12) Patent Application Publication
(10) Pub. No.: US 2014/0255896 A1
(43) Pub. Date: Sep. 11, 2014

(54) AUTOMATED TESTING AND IMPROVEMENT OF TEACHING APPROACHES

(71) Applicant: APOLLO GROUP, INC., Phoenix, AZ (US)

(72) Inventors: Partha Saha, Oakland, CA (US); Pradeep Ragothaman, Sunnyvale, CA (US); Kurtis Taylor, Mesa, AZ (US)

(73) Assignee: APOLLO GROUP, INC., Phoenix, AZ (US)

(21) Appl. No.: 13/788,112

(22) Filed: Mar. 7, 2013

(51) Int. Cl. G09B 7/00

(52) U.S. Cl. CPC G09B 7/00
USPC 434/350

(57) ABSTRACT

Techniques are provided for testing alternative teaching approaches for specific portions of a curriculum. Test-triggering rules are established, each of which corresponds to a specific target-area. Each test-triggering rule specifies conditions which, if satisfied, indicate that a new teaching approach should be tested for the test-triggering rule's target-area. Once the test-triggering rules are established, the assessment results produced by students in instances of courses that implement the curriculum are monitored. If the assessment results satisfy the conditions, a revised teaching approach is selected for the target-area. The revision is then pushed out in waves where some course takers see the revision and others are held constant (A/B analysis). If a hypothesis is validated, then the appropriate revision can be permanently adopted.

### FIELD OF THE INVENTION

The present invention relates to automated testing and improvement of teaching approaches.

### BACKGROUND

Educators are engaged in the never-ending search for the best ways to teach subject matter. How particular subject matter is taught is referred to herein as the “teaching approach” for the subject matter. Thus, the term “teaching approach” refers to both the teaching method used to teach the subject matter, and the materials used to teach the subject matter. The materials used to teach subject matter include both the materials used to convey knowledge of the subject matter, and the materials used to assess a student's understanding of the subject matter.

When a new teaching approach is developed for a particular course, some educators may adopt the new teaching approach on a trial basis. If, at the end of the course in which the new teaching approach was used, students appear to have learned the subject matter better than previous offerings of the course, then the educators may adopt the new teaching approach permanently. On the other hand, if the students have not learned the subject matter as well as in previous offerings of the course, then the educator may revert to the prior teaching approach when teaching the course in subsequent semesters.

This conventional manner of revising teaching approaches is relatively slow, subjective, and inefficient. For example, it may take an entire semester or year to collect enough data/evidence to determine that the new teaching approach is inferior.

Further, due to the infrequent offering of courses (e.g. a particular course may be offered only once a year), the opportunities to revise the teaching approach used in the course is also infrequent. Consequently, educators that believe that the teaching approach for the course requires improvement are more likely to make several sweeping changes at each opportunity, rather than incremental changes. Unfortunately, when several sweeping changes are made at once, it is difficult to assess which changes actually improved things, and which did not.

Another problem with the conventional manner of changing teaching approaches is that new teaching approaches may be developed much faster than they can be tested. For example, prior to beginning of a course, the teacher may have to decide whether to stick with a previously-used teaching approach for the course, or to use one of dozens of newly-developed teaching approaches for the course. Even when the teacher opts to try one of the new teaching approaches, there is no guarantee that the selected approach will yield far better results than either the old approach or the other new approaches that were not selected.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a diagram illustrating the process of monitoring performance while using a default teaching approach to determine whether a test-triggering rule is satisfied, according to an embodiment;

FIG. 2 is a diagram illustrating the process of testing different teaching approaches for a target-area, according to an embodiment; and

FIG. 3 is a block diagram of a computer system that may be used to implement embodiments of the invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described herein for testing alternative teaching approaches for specific portions of a curriculum while courses intended to satisfy the goals of the curriculum are in progress. According to one embodiment, test-triggering rules are established, each of which corresponds to a specific portion of curriculum. The portion of the curriculum that corresponds to a particular test-triggering rule is referred to herein as the “target-area” of the test-triggering rule.

Each test-triggering rule specifies conditions which, if satisfied, indicate that a new teaching approach should be tested for the test-triggering rule's target-area. The conditions of a test-triggering rule may be, for example, that the aggregate percentage of success on particular assessments falls below a certain threshold.

Once the test-triggering rules are established, the assessment results produced by students are monitored. The monitoring may be performed in online instances of courses that implement the curriculum, or on online components of conventional in-person courses. If the assessment results satisfy the conditions associated with a test-triggering rule, alerts can be raised for the target-areas whose test-triggering rules were triggered, thereby indicating that parts of the curricular/instructional goals need further work. An Instructional Designer or Learning Specialist or Course Instructor/Faculty at this stage can dig deeper into the performance of the students on these assessments and come up with various hypotheses for why the performance has been inadequate.

Each hypothesis can be tested by revising the parts of courses that correspond to the target-area. This revision can then be pushed out in waves where some randomly selected course takers see the revision(s) and others are held constant (A/B analysis). If a hypothesis is validated, then the appropriate revision can be permanently applied to the course. If the hypothesis is not validated, new hypotheses may be generated and tested until the desired outcome is achieved.

### Test-Triggering Rules

As mentioned above, a test-triggering rule is a rule, associated with a particular target-area, that specifies conditions for when alternative teaching approaches for that target-area should be tested. The conditions defined by a test-triggering rule may range from simple to arbitrarily complex. An example of a simple test-triggering rule is “test alternative teaching approaches for fractions if the average score on the fraction exam is below 75%”. In this example, when the average score on the fraction exam falls below 75%, the conditions associated with the rule are satisfied. In response to satisfaction of the conditions of the rule, an alert is generated to indicate alternative teaching approaches should be tested for the target-area “fractions”.

According to one embodiment, such alerts indicate the target-area to which they correspond (e.g. fractions), and may further indicate the conditions associated with the corresponding test-triggering rule (e.g. average score on the fraction exam<75%), and the actual student performance statistics that satisfied those conditions (e.g. average score on the fraction exam=71.2%). The alert may also indicate, or include a link to a page that indicates, a more detailed view of the data that caused the conditions to be satisfied. For example, the alert may include a link to a report that indicates the average score for each question on the fraction exam. In addition to the data that caused the conditions to be satisfied, the alert may also include a link to the material currently used to teach the target-area. Based on the information contained in or linked to the alert, the recipient of the alert may quickly obtain the information needed to form a hypothesis about how to improve the teaching approach for the target-area, and make a revised version of the teaching approach to be used to test the hypothesis.

More complex test-triggering rules may make use of instructional ontologies, such as those used in the systems described in U.S. patent application Ser. Nos. 13/007,147, and 13/007,177, both of which were filed Jan. 14, 2011, both of which are incorporated herein, in their entirety, by this reference.

In those systems, assessments are tagged with nodes of a detailed hierarchical breakdown of curricular/instructional goals comprising an instructional ontology of an online course. As students engage in the assessments in various instances of the online course, test-triggering rules can be used to establish a threshold for an aggregate expected percentage of success. Such thresholds may be established at any level of granularity. For example, success thresholds may be established on a per-question basis, per-test basis, per-chapter basis, per-concept basis, per-objective basis, per-unit basis, per-course basis, per-major basis, etc. In such an embodiment, if the thresholds are not exceeded, alerts can be raised to indicate that the target-areas need further work. In response to such alerts, testing of alternative teaching approaches for those target-areas is initiated.

### Rules for Specific Target-Area/Target-Group Combinations

Test-triggering rules may be restricted not only with respect to a particular target-area of the curriculum, but also with respect to specific groups of students. For example, a particular course may use a different teaching approach to teach fractions to students over 20 years old than is used to teach fractions to students under 20 years old. To determine whether the teaching approach that is used for students over 20 should be tested, a group-specific test-triggering rule may be that students over 20 years old must obtain an average score above 75% on fraction tests. In this case, only the performance of students over 20 years old would be taken into account when determining whether the test-triggering rule is triggered.

While the performance of students over 20 are being compared against the conditions of one test-triggering rule, the performance of students under 20 may be compared against the conditions of a different test-triggering rule that has been established for target-area/target-group combination of (fractions, students under 20). Even though it is for the same target-area, the test-triggering rule for (fractions, students under 20) may have different conditions than the test-triggering rule for (fractions, students over 20). For example, the test-triggering rule for (fractions, students under 20) may be that students under 20 must obtain an average score above 70% on fraction tests.

This is merely one example of how the same target-area (e.g. fractions) may have many distinct test-triggering rules, each of which is for a different category of students. Further, individual students may belong to multiple categories. For example, a distinct test-triggering rule may be established for each of: (fractions, students over 20), (fractions, students under 20), (fractions, males), (fractions, females), (fractions, native English speakers), (fractions, non-native English speakers), etc. In this example, the fraction test score of a native English speaking female over 20 would be taken into account when evaluating at least three distinct rules: the rules for (fractions, students over 20), (fractions, females) and (fractions, native English speakers).

### Selecting a Revised Teaching Approach

The teaching approach that was being used to teach a target-area when the target-area's test-triggering rule was triggered is referred to herein as the “default teaching approach”. The fact that the test-triggering rule was triggered while the default teaching approach was being used indicates that the default teaching approach for the target-area may require improvement. However, knowing that the default teaching approach requires improvement does not necessarily bestow the knowledge of how the default teaching approach may be improved. For example, there may be numerous known alternatives to the default teaching approach, and it may not be clear which alternative, if any, would produce an improvement.

In one embodiment, an Instructional Designer or Learning Specialist or Course Instructor/Faculty may dig deeper into the performance of the students that performed poorly on the assessments associated with a target-area whose rule was satisfied. After studying the matter, the Instructional Designer or Learning Specialist or Course Instructor/Faculty may come up with various hypotheses for why the performance has been inadequate. After formulating a hypothesis, the Instructional Designer or Learning Specialist or Course Instructor/Faculty may propose an alternative teaching approach for the target-area which, if the hypothesis is correct, will result in improvement in the target-area. The Instructional Designer or Learning Specialist may propose alternative teaching approaches based on the Target-Group combination. For example, the proposed approach for Teaching Fractions to Students over 20 may be different than the proposed approach for Students under 20.

In an alternative embodiment, the selection of a revised teaching approach may be automated. For example, there may be several known teaching approaches for the target-area. In response to the test-triggering rule of a target-area being triggered, a system may automatically select one of the available teaching approaches to be the revised teaching approach against which the default teaching approach is tested.

### Revision Granularity

According to one embodiment, the target-area testing techniques described herein are performed in an environment in which, at any point in time, multiple instances of the same course may be occurring. For example, the techniques may be used in a conventional or online education environment where a new instance of the same semester-long course may be initiated every week, or even every day. As another example, the techniques may be used in an education environment where each student effectively has his/her own instance of the course, rather than progressing lock-step through the course with any particular group of other students. In these and many other environments, there are frequent opportunities to perform A/B testing of target-areas. For example, during one week a class of students may be exposed to A/B testing of teaching approaches A and B for a particular target-area, and during the next week a different class of students may be exposed to A/B testing of teaching approaches A and C for the same target-area. Further, which the technique is called “A/B testing”, it may be extended to concurrently test multiple options. For example, testing A/B, A/C and A/D can be performed simultaneously.

In situations where a course is offered once a year, rapid improvement may require sweeping changes between one offering of the course and the next. Unfortunately, after a set of sweeping changes, it is hard to assess which changes were beneficial, and which are not. On the other hand, if the same course is offered frequently, then each offering may be used to test a single revision, or a small set of non-interfering revisions. Under these circumstances, it is much easier to assess the effect of each individual change. Further, the small frequent changes may, when taken collectively, result in a faster rate of improvement than annual sweeping changes.

Therefore, in environments where A/B testing of teaching approaches may be performed relatively frequently, the amount of revision that is tested during each testing period may be small. Examples of fine-granularity revisions include, but are not limited to:
changing the wording of a question
changing a distractor used in a question
changing the feedback given after a knowledge check
changing the material used to teach one concept
changing the form in which feedback is given
changing the sequence in which questions or concepts are presented

These are merely examples of the virtually unlimited number of ways a teaching approach may be revised to create a revised teaching approach that can then be tested against the default teaching approach. The techniques described herein are not limited to making any particular type of revision to produce the revised teaching approach.

### Automatically Testing a Target-Area

After a revised teaching approach has been selected, a testing period is initiated to see if the revised teaching approach improves performance in the target-area. During the testing period, the revised teaching approach is pushed out in waves, where some randomly selected students are exposed to the revised teaching approach while others are exposed to the default teaching approach (A/B analysis). The period during which two or more different teaching approaches are being used to teach a particular target-area is referred to herein as the “testing period” for the target-area.

The hypothesis upon which the revised teaching approach is based may be validated or invalidated based on the results of assessments made during the testing period. If a hypothesis is validated (e.g. the corresponding revised teaching approach sufficiently improves performance), then the appropriate revision can be permanently applied to the course. On the other hand, if a hypothesis is invalidated (e.g. the corresponding revised teaching approach does not sufficiently improve performance), then the curriculum may be “rolled back” to the teaching approach that was in effect at the time the test-triggering rule was satisfied.

### Testing Duration

According to one embodiment, the duration of a testing period varies based on one or more factors. For example, the duration of the testing period may be based on how long it takes to gather sufficient data points to determine, within a certain level of confidence, whether the hypothesis was validated (i.e. whether the revised teaching approach is better than the default teaching approach). In such an embodiment, if the class size in each offering of the course is small, then the duration of the testing period may be relatively long. On the other hand, if the class size in each offering of the course is large, then the duration of the testing period may be relatively short. When a test is limited to a particular student group (e.g. students over 20), then the duration of the testing period may be longer if the student group corresponds to a small fraction of the students that take the course.

According to one embodiment, when the system has gathered sufficient data during the testing period to determine, with a predetermined degree of confidence, whether the hypothesis is valid, the system automatically generates a “testing concluded” alert. The testing concluded alert may indicate, for example, the target-area that was being tested, the two or more teaching approaches that were being tested for the target-area, and the results produced by students for each of the teaching approaches. For example, the testing concluded alert may indicate that the target-area is fractions, that the test involved teaching approach A (e.g. one wording of the test questions) and teaching approach B (e.g. another wording of the test questions), and that students exposed to teaching approach A scored an average of 60% on the fraction test, while students exposed to teaching approach B scored an average of 78% on the fraction test.

### Concurrent Testing of Non-Interfering Target-Areas

The testing periods for multiple target-areas may overlap, resulting in concurrent testing for multiple target-areas. However, it is preferable that any target-areas that are concurrently tested are selected such that there may be a high degree of confidence that particular revisions are responsible for specific changes in performance. For example, during a particular testing period, it may not be desirable to test both (a) alternative wordings for a particular test question and (b) alternative ways of teaching the concepts that are tested in the particular test question. If both are tested and performance improves, it is not clear whether the improvement resulted from the change in test question wording, the change in teaching the concepts, or both.

As long as it is relatively clear which teaching approach changes account for which performance changes, many target-areas may be tested concurrently. For example, during the same testing period, alternative wordings for many different test questions may be tested. In this example, the concurrent testing of target-areas may be acceptable as long as the changed wording of one question is not likely to have a significant effect on performance relative to another question whose wording is also being tested.

### “Sufficient” Improvement

According to one embodiment, improvement in a target-area is deemed “sufficient” to adopt a revised teaching approach for the target-area when using the revised teaching approach fails to trigger the test-triggering rule associated with the target-area. For example, assume that the target-area is a particular set of questions, relating to fractions, on a particular math test. Assume further that the test-triggering rule for that target-area is that, on average, students fail to answer 50% of those questions correctly.

Under these circumstances, when the student average for those questions falls below 50%, a revised teaching approach may be selected for the target-area. In the present example, the revised teaching approach may be new wordings for one or more of the test questions. If, during the testing period, an average score of 50% or more is obtained by those students exposed to the new question wordings, then the improvement may be deemed sufficient, and the revised teaching approach is adopted. On the other hand, if an average score of 50% is not attained using the revised teaching approach, then the curriculum is rolled back to the original test question wording.

In alternative embodiments, the conditions for triggering the testing of a target-area are different from the conditions for adopting a new teaching approach. For example, even though testing is triggered by the average score falling below 50%, the conditions for adopting a revised teaching approach may be that the average score exceeds 60%. By establishing relatively restrictive conditions for adopting a new teaching approach, the frequency at which the curriculum for any particular target-area changes is reduced. That is, very slight improvements do not automatically trigger a teaching approach change. Instead, the default teaching approach continues to be tested against alternatives until an alternative is found that produces significant improvement.

### Example Operation During a Non-Testing Period

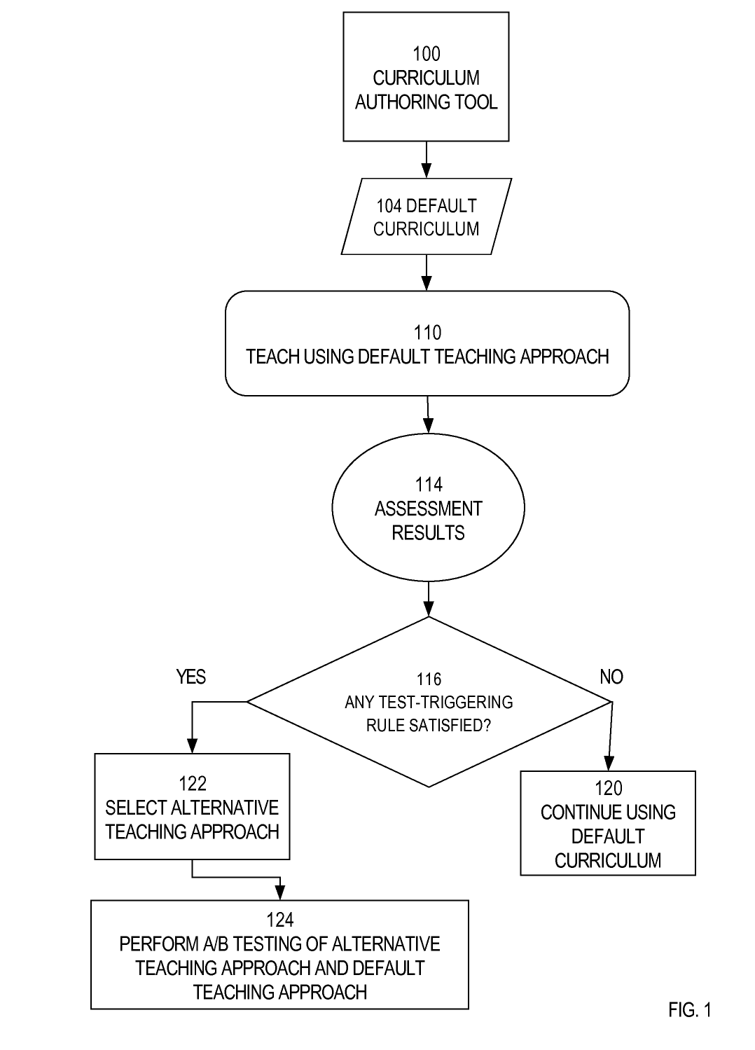

Referring to FIG. 1, it illustrates the scenario in which a particular target-area is not experiencing a testing period. Specifically, a curriculum authoring tool 100 is used to create the default curriculum 104 for a course that includes the particular target-area. For example, the target-area may be fractions, and the curriculum authoring tool 100 may be used to create material for teaching fractions, and to create assessments to test knowledge of fractions.

Initially (at block 110), the target-area (fractions) is taught using the default curriculum. At block 114, the assessment results are analyzed to see how well students are performing relative to the target-area. At block 116, it is determined whether the test-triggering rule of any target-area is satisfied. For example, the test-triggering rule that corresponds to fractions may be that the teaching approach for fractions should be tested when the average score on the fraction-related quiz questions falls below 50%. If the assessment results 114 indicate that average performance on the fraction-related quiz questions fell below 50%, then the test-triggering rule for “fractions” was satisfied.

If no test-triggering rule is satisfied in block 116, at block 120 the default curriculum 104 continues to be used. On the other hand, if the test-triggering rule of any target-area is satisfied, then at block 122 alternative teaching approaches are selected for one or more of the target-areas whose test-triggering rules were satisfied. At block 124, A/B testing is performed using the default teaching approach and the selected alternative teaching approach.

### Example Operation During a Testing Period

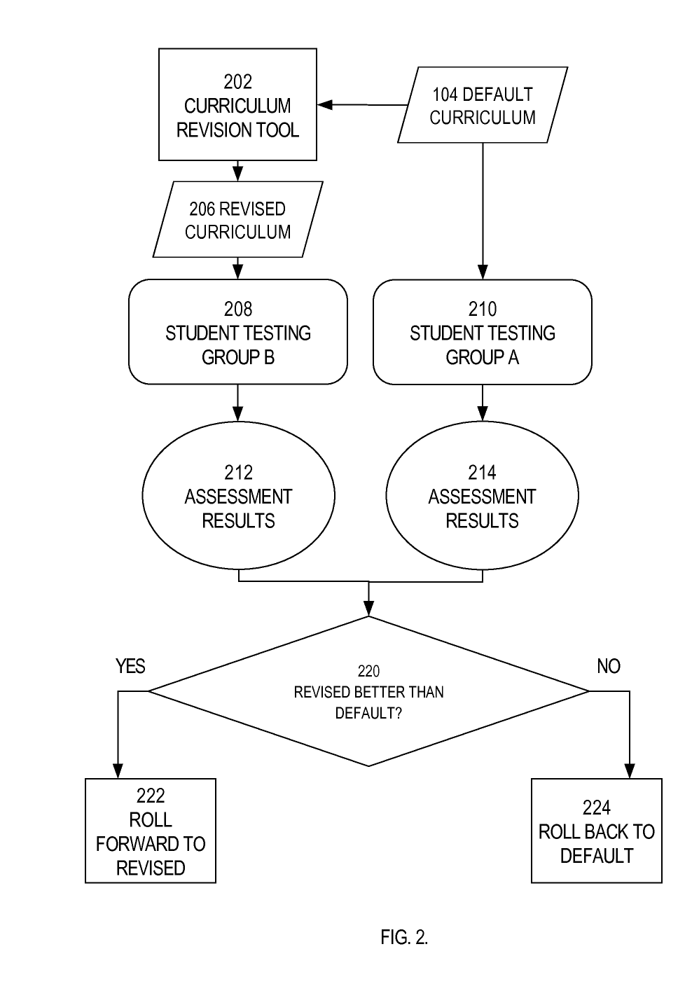

Referring to FIG. 2, it illustrates a scenario in which a particular target-area is experiencing a testing period. Specifically, a curriculum revision tool 202 is used to revise the default curriculum 104 in a manner that is intended to improve the portion of the curriculum that is associated with a target-area whose test-triggering rule was satisfied. As explained above, the revision may be based on a hypothesis formulated after studying the default teaching approach for the target-area, and the corresponding performance on assessments.

For example, if the average score on the fraction-related questions falls below 50%, then the wording of the questions may be investigated. If it appears that some of the questions are worded in a confusing manner, curriculum revision tool 202 may be used to create alternative wording for the questions at issue. The curriculum with the revised questions constitutes a revised curriculum 206.

During the testing period, the revised curriculum 206 is presented to one set of students 208, while the default curriculum 104 is presented to another set of students 210. Assessment results 212 from the first set of students 208 are compared to the assessment results 214 of the second set of students 210 to determine (at block 220) whether the revised curriculum 206 produced better results than the default curriculum 104. If so, the curriculum is rolled forward (block 222) so that the revised curriculum 206 becomes the new “default curriculum”. On the other hand, if the revised curriculum 206 does not produce better results than the default curriculum 104, then the curriculum is rolled back to the default curriculum 104.

While FIG. 2 illustrates an example where two alternative approaches are tested, there is no limit to the actual number of alternative approaches that are concurrently tested during a testing period. For example, during the same testing period, five different approaches may be tested, where different sets of students are subjected to each approach.

Rolling back does not necessarily mean that testing ends. For example, after the curriculum is rolled back, a new testing period may begin in which the default curriculum 104 is A/B tested against another type of revision. For example, if the first attempt to reword the fraction-related questions does not cause improved performance, then the fraction-related questions may be reworded a different way, and the new rewording can be tested against the default wording.

In the embodiment illustrated in FIG. 2, the revisions are adopted if they result in improved performance relative to the default curriculum. However, as mentioned above, adoption of revisions may require more than simply producing better results. For example, adopting a revision may require a certain amount of improvement (e.g. 10% higher test scores, or average test scores of 75% or better). Thus, in some embodiments, even “better” teaching approaches may not be adopted if they are not sufficiently better than the default teaching approaches.

### Target-Area-Specific Test-Triggering Rules and Adoption Rules

As mentioned above, the test-triggering rule for a particular target-area may use different conditions than are used by the revision-adoption rule for the target-area. Thus, a test score average below 50% may trigger the testing of a particular target-area, but adopting a revised teaching approach for that particular target-area may require test score averages above 55%.

Similarly, the test-triggering rules for one target-area may differ from the test-triggering rules for a different target-area. For example, the test-triggering rules may be established as follows:
Target-area: fractions. Test-triggering rule: average score on questions 1, 5, 12 of Test A, and questions 7, 9, 15 of Test B is below 50%
Target-area: division. Test-triggering rule: average score on questions 1, 6, 15 of Test A, questions 9, 23 and 24 of Test B, and question 4 of Test C is below 66%
Target-area: word problems. Test-triggering rule: students, on average, request any word problem in any of tests A, B and C to be read back to them more than three times.

As is evident by these examples, the same assessment may be involved in many test-triggering rules. For example, for each of the three target-areas, student performance on Tests A and B affect whether corresponding test-triggering rules are satisfied. More specifically, assuming that question 1 of Test A is a word problem, how students handle that single question may affect whether the teaching approach for any one of the three target-areas needs to be tested.

### Automatically Segmenting the Target-Population

Certain teaching approaches may work better with certain segments of a student population. However, it is not always easy to divide the student population into segments with similar learning characteristics. For example, each student's profile may have data about fifty attributes of the student. However, not all attributes may be equally relevant in determining which teaching approaches work best for teaching the student in a particular target-area. Further, the attributes that are relevant in determining which teaching approach works best for the student in one target-area may not be the attributes that are relevant in determining which teaching approach works best for the student in another target-area.

According to one embodiment, in addition to monitoring test-triggering rules based on results of the entire student population, the same test-triggering rules may be tested against different segments of the student population. Various mechanisms may be used to determine which attribute, or combination of attributes, should be used to initially divide the student population into segments. Once divided into segments, the segments may be evaluated separately. If all segments test similarly, then different attributes can be selected for segmenting the student population. However, if a particular segment of the population produces significantly different results when taught the same target-area with the same teaching approach as the rest of the students, then the attributes by which that segment was formed may be determined to be relevant attributes for segmenting the population into target-groups, at least with respect to that particular target-area.

For example, assume that the test-triggering rule for fractions is an average score of 50% or less on a particular test. The data gathered while monitoring student performance may indicate an average score of 65% across the entire student population. However, the test-triggering rule may be applied against smaller segments of the population, where males achieve an average of 62%, native-English-speakers achieve an average of 68%, and males under 20 achieve an average of 30%. Under these conditions, the results of the “males under 20” group are significantly different than the overall population. Thus, based on this outcome, the gender/age combination may be automatically selected as that attribute combination by which to segment the student population, at least relative to the target-area of “fractions”.

Once broken up into segments in this manner, the test-triggering rules may be applied separately to the results produced by each segment. When a particular segment triggers a test-triggering rule, then only that segment may be subjected to A/B testing. If, as a result of the A/B testing of that segment, it is determined that the revised teaching approach is better, then the revised teaching approach may be adopted for only members of that segment. Thus, over time, not only does the curriculum for a course improve for the student population as a whole, but the curriculum improves by evolving separately for each distinct segment of the student population.

The student population may also be segmented after a testing period in response to determining that a hypothesis has been validated for only a specific subset of the student population. For example, assume that during a testing period for the target-area “fractions”, teaching approaches A and B were tested. The outcome of the testing may indicate that, in general, teaching approach B is not sufficiently better than teaching approach A. However, when the test results for specific segments are analyzed, it may turn out that teaching approach B is significantly better for non-native English speakers under age 20. In response to this discovery, teaching approach B may be adopted for only that specific segment of students, while teaching approach A remains the default teaching approach for the remainder of the students.

### Course Versioning

According to one embodiment, the teaching platform to which curriculum authoring tool 100 and curriculum revision tool 202 belong includes a versioning mechanism that keeps track of which version of a course is the default version, and which versions of the course are currently being tested. For example, assume that a course X has three target-areas A, B and C. The default version of course X may have target-area A being taught with teaching approach A, target-area B being taught with teaching approach B, and target-area C being taught with teaching approach C. This exact target-area-to-teaching approach mapping may constitute “version 1” of the course.

According to one embodiment, each distinct target-area-to-teaching approach mapping constitutes a distinct version of the course. For example, as explained above, after a test-triggering rule is triggered, a testing period is initiated in which a different version of the course is presented to some students. For example, assume that the test-triggering rule for target-area A is triggered. In response, teaching approach Q may be selected for testing against teaching approach A, with respect to target-area A. This creates a new target-area-to-teaching approach mapping (i.e. target-area A/teaching approach Q, target-area B/teaching approach B, target-area C/teaching approach C). This new target-area-to-teaching approach mapping may constitute a new “version 2” of the course. If, after the testing, teaching approach Q is adopted as the teaching approach for target-area A, then version 2 replaces version 1 as the default version of the course.

In embodiments where teaching approaches are tested on a target-group basis, any given course may have multiple “default” versions, where each of the segments into which the students have been divided has its own default version. For example, version 1 of the course may be the default version of the course with respect to one target-group (e.g. students over 20), while version 2 of the course is the default version of the course with respect to another target-group (e.g. students under 20). Because there may be a large number of distinct target groups in a course, there may be an equally large number of default versions of the course.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

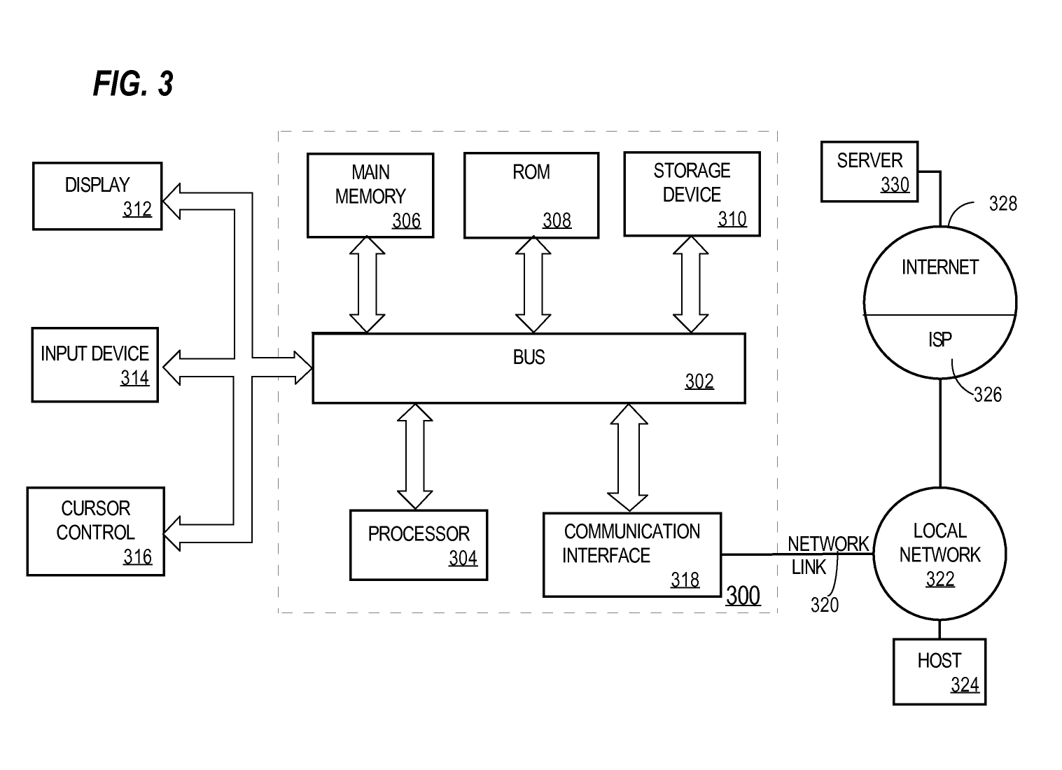

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
while a first teaching approach is being used to teach a specific target-area of a course, monitoring student performance for the specific target-area of the course to determine whether the student performance satisfies conditions specified in a test-triggering rule established for the specific target-area;
while monitoring student performance for the specific target-area, automatically detecting that the conditions specified in the test-triggering rule for the specific target-area are satisfied;
after detecting that the conditions specified in the test-triggering rule for the specific target-area are satisfied, selecting at least one second teaching approach for the specific target-area of the course; and
during a testing period of time, using the first teaching approach to teach the specific target-area to a first set of students in the course, and using the at least one second teaching approach to teach the specific target-area to at least one second set of students in the course;
based at least in part on performance of the at least one second set of students during the testing period, determining which of the following actions to perform:
adopting the at least one second teaching approach for teaching the specific target-area of the course; or
rolling back to using the first teaching approach for teaching the specific target-area of the course;
wherein at least the steps of monitoring and detecting are performed automatically by one or more computing devices.

2. The method of claim 1 wherein:
the specific target-area is one of a plurality of target-areas for which test-triggering rules have been established;
the step of monitoring includes concurrently monitoring student performance in each of the plurality of target-areas to determine whether student performance in any of the plurality of target-areas satisfies conditions in the test-triggering rule of the corresponding target-area.

3. The method of claim 2 wherein:
the plurality of target-areas include a first target-area and a second target-area; and
conditions that trigger the test-triggering rule of the first target-area are different than conditions that trigger the test-triggering rule of the second target-area.

4. The method of claim 1 wherein:
the conditions specified in the test-triggering rule for the specific target-area relate to student performance on certain questions on one or more tests;
the one or more tests include a particular test; and
the certain questions include some but not all of the questions on the particular test.

5. The method of claim 2 further comprising: based on results of concurrently monitoring student performance in each of the plurality of target-areas, determining that the conditions in the test-triggering rules for at least two of the target-areas were satisfied.

6. The method of claim 1 wherein the first teaching approach and the at least one second teaching approach correspond to different wordings of one or more questions used to test student knowledge of the specific target-area.

7. The method of claim 1 wherein the first teaching approach and the at least one second teaching approach correspond to different wordings of material used to convey knowledge relating to the specific target-area.

8. The method of claim 1 further comprising automatically generating an alert in response to detecting that the conditions specified in the test-triggering rule for the specific target-area are satisfied.

9. The method of claim 1 wherein:
the test-triggering rule for the specific target-area is one of a plurality of test-triggering rules for the specific target-area; and
each test-triggering rule, of the plurality of test-triggering rules for the specific target-area, is for a different category of students.

10. The method of claim 1 wherein the testing period has a duration that is based on how long it takes to gather sufficient statistics to determine, with a certain degree of confidence, which of the first teaching approach and the at least one second teaching approach results in superior student performance.

11. The method of claim 1 further comprising:
during the testing period of time, automatically detecting when sufficient data points have been collected to determine, within a certain degree of confidence, whether the at least one second teaching approach is better for teaching the specific target-area than the at least one second teaching approach; and
in response to detecting that sufficient data points have been collected, automatically generating an alert to indicate that sufficient data points have been collected.

12. The method of claim 1 further comprising:
based at least in part on performance of the at least one second set of students during the testing period, selecting a particular combination of attributes;
creating a plurality of segments by automatically segmenting a population of students based on the particular combination of attributes; and
using different teaching approach, for the specific target-area, for each segment of the plurality of segments.

13. The method of claim 1 wherein the course is an online course.

14. One or more non-transitory computer-readable media storing instructions which, when executed by one or more processors, cause performance of a method comprising:
while a first teaching approach is being used to teach a specific target-area of a course, monitoring student performance for the specific target-area of the course to determine whether the student performance satisfies conditions specified in a test-triggering rule established for the specific target-area;
while monitoring student performance for the specific target-area, automatically detecting that the conditions specified in the test-triggering rule for the specific target-area are satisfied;
after detecting that the conditions specified in the test-triggering rule for the specific target-area are satisfied, selecting at least one second teaching approach for the specific target-area of the course; and
during a testing period of time, using the first teaching approach to teach the specific target-area to a first set of students in the course, and using the at least one second teaching approach to teach the specific target-area to at least one second set of students in the course;
based at least in part on performance of the at least one second set of students during the testing period, determining which of the following actions to perform:
adopting the at least one second teaching approach for teaching the specific target-area of the course; or
rolling back to using the first teaching approach for teaching the specific target-area of the course;
wherein at least the steps of monitoring and detecting are performed automatically by one or more computing devices.

15. The one or more non-transitory computer-readable media of claim 14 wherein:
the specific target-area is one of a plurality of target-areas for which test-triggering rules have been established;
the step of monitoring includes concurrently monitoring student performance in each of the plurality of target-areas to determine whether student performance in any of the plurality of target-areas satisfies conditions in the test-triggering rule of the corresponding target-area.

16. The one or more non-transitory computer-readable media of claim 15 wherein:
the plurality of target-areas include a first target-area and a second target-area; and
conditions that trigger the test-triggering rule of the first target-area are different than conditions that trigger the test-triggering rule of the second target-area.

17. The one or more non-transitory computer-readable media of claim 14 wherein:
the conditions specified in the test-triggering rule for the specific target-area relate to student performance on certain questions on one or more tests;
the one or more tests include a particular test; and
the certain questions include some but not all of the questions on the particular test.

18. The one or more non-transitory computer-readable media of claim 15 wherein the method further comprises: based on results of concurrently monitoring student performance in each of the plurality of target-areas, determining that the conditions in the test-triggering rules for at least two of the target-areas were satisfied.

19. The one or more non-transitory computer-readable media of claim 14 wherein the first teaching approach and the at least one second teaching approach correspond to different wordings of one or more questions used to test student knowledge of the specific target-area.

20. The one or more non-transitory computer-readable media of claim 14 wherein the first teaching approach and the at least one second teaching approach correspond to different wordings of material used to convey knowledge relating to the specific target-area.

21.-25. (canceled)
